(19) United States
(12) Patent Application Publication
(10) Pub. No.: US 2011/0032672 A1
(43) Pub. Date: Feb. 10, 2011

(54) Memory Heat Sink System

(75) Inventors: Paul T. Artman, Austin, TX (US); Shawn P. Hoss, Round Rock, TX (US); William K. Coxe, III, Round Rock, TX (US)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 12/538,332

(22) Filed: Aug. 10, 2009

(51) Int. Cl. G06F 1/20; B23P 11/00

(52) U.S. Cl. 361/679.47; 29/428

(57) ABSTRACT

A memory heat sink system includes a base comprising a first side and a second side, wherein the first side is oriented substantially perpendicularly to the second side. A plurality of convective heat transfer members extend from the first side. At least one conductive liquid cooling coupling surface located on the second side.

### BACKGROUND

The present disclosure relates generally to information handling systems, and more particularly to a memory heat sink system for an information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Most IHSs utilize forced convective cooling to meet the thermal requirements of their internal components such as, for example, memory modules. Typically, a forced convection heat sink is attached to the memory module, and then a fan is used to force air over the forced convection heat sink. Heat is transferred from the memory module, to the forced convection heat sink, and then to the air in order to cool the memory module. However, in some situations, conductive liquid cooling can offer advantages over forced convective cooling such as, for example, higher cooling efficiency, reduced downstream component preheating, an opportunity to remove the heat load from, for example, a data center to a chilled water facility. If conductive liquid cooling is chosen, typically a liquid cooling heat sink (which includes features that allow it to couple to a liquid cooling plate) is attached to the memory module, and then a liquid cooling plate is coupled to the liquid cooling heat sink. Heat is then transferred from the memory module, to the liquid cooling heat sink, and then to the liquid in the liquid cooling plate.

The cooling options detailed above may result in problems as, in some situations, the memory modules may not require conductive liquid cooling, and use of the force convective cooling may provide a less complicated and less expensive option. However, that situation may change due to changes in the IHS, increased demands on the IHS, and/or a variety of other reasons known in the art, and conductive liquid cooling may be necessary to meet the cooling requirements of the IHS components. This may force a user or manufacturer to provide two sets of heat sinks (i.e., a forced convection heat sink and a conductive liquid cooling heat sink) for each memory module in the system in order to be able to use either force convective cooling or conductive liquid cooling when the system requires it, which raises costs.

Accordingly, it would be desirable to provide an improved memory heat sink system.

### SUMMARY

According to one embodiment, a memory heat sink system includes a base comprising a first side and a second side, wherein the first side is oriented substantially perpendicularly to the second side, a plurality of convective heat transfer members extending from the first side, and at least one conductive liquid cooling coupling surface located on the second side.

### BRIEF DESCRIPTION OF THE DRAWINGS

FIG. 1 is a schematic view illustrating an embodiment of an IHS.

FIG. 2 is a perspective view illustrating an embodiment of a memory module.

FIG. 3 is an exploded perspective view illustrating an embodiment of a heat sink system.

FIG. 4a is a flow chart illustrating an embodiment of a method for cooling a memory module.

FIG. 4b is an exploded perspective view illustrating an embodiment of the heat sink system of FIG. 3 being coupled to the memory module of FIG. 2.

FIG. 4c is a perspective view illustrating an embodiment of the heat sink system of FIG. 3 coupled to the memory module of FIG. 2.

FIG. 4d is side view illustrating an embodiment of the heat sink system of FIG. 3 coupled to the memory module of FIG. 2.

FIG. 4e is front view illustrating an embodiment of the heat sink system of FIG. 3 coupled to the memory module of FIG. 2.

FIG. 4f is a perspective view illustrating an embodiment of a plurality of the memory modules including the heat sink system coupled to an IHS.

FIG. 4g is a perspective view illustrating an embodiment of a plurality of the memory modules including the heat sink system coupled to an IHS with a conductive liquid cooling device coupled to the heat sink systems.

FIG. 4h is a front view illustrating an embodiment of a plurality of the memory modules including the heat sink system coupled to an IHS with a conductive liquid cooling device coupled to the heat sink systems.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

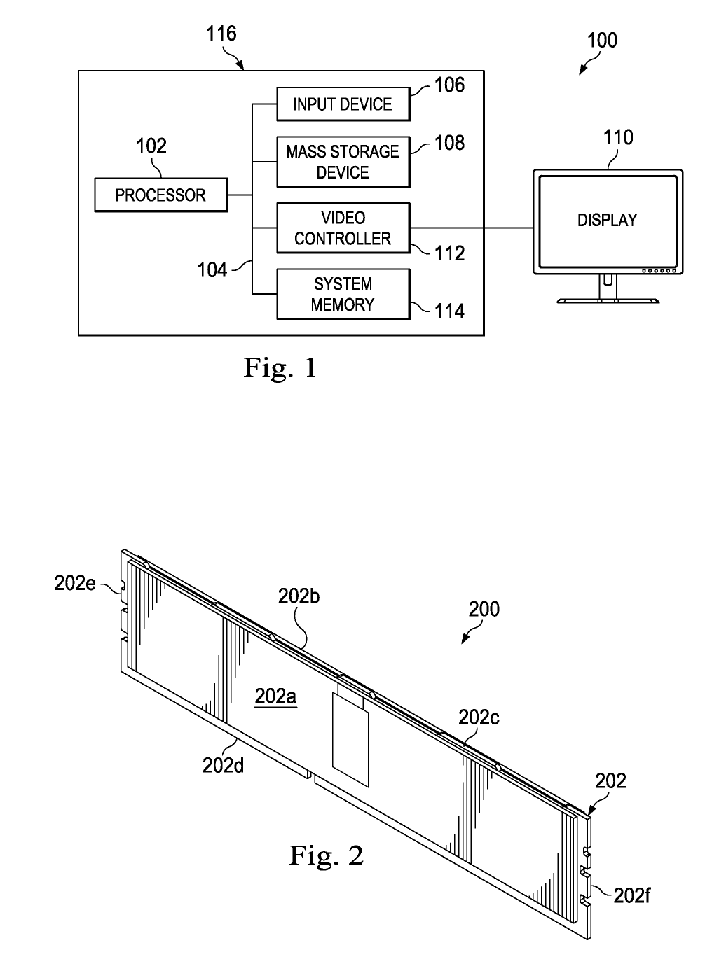

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

Referring now to FIG. 2, a memory module 200 is illustrated. The memory module 200 includes a base 202 having a front surface 202a, a rear surface 202b located opposite the front surface 202a, a top edge 202c extending between the front surface 202a and the rear surface 202b, a bottom edge 202d located opposite the top edge 202c and extending between the front surface 202a and the rear surface 202b, and a pair of opposing side surfaces 202e and 202f extending between the front surface 202a, the rear surface 202b, the top edge 202c, and the bottom edge 202d. In an embodiment, the memory module 200 may include a variety of memory components known in the art on the front surface 202a and/or the rear surface 202b. In an embodiment, the memory module 200 is compliant with one or more Joint Electron Deice Engineering Council (JEDEC) memory standards known in the art.

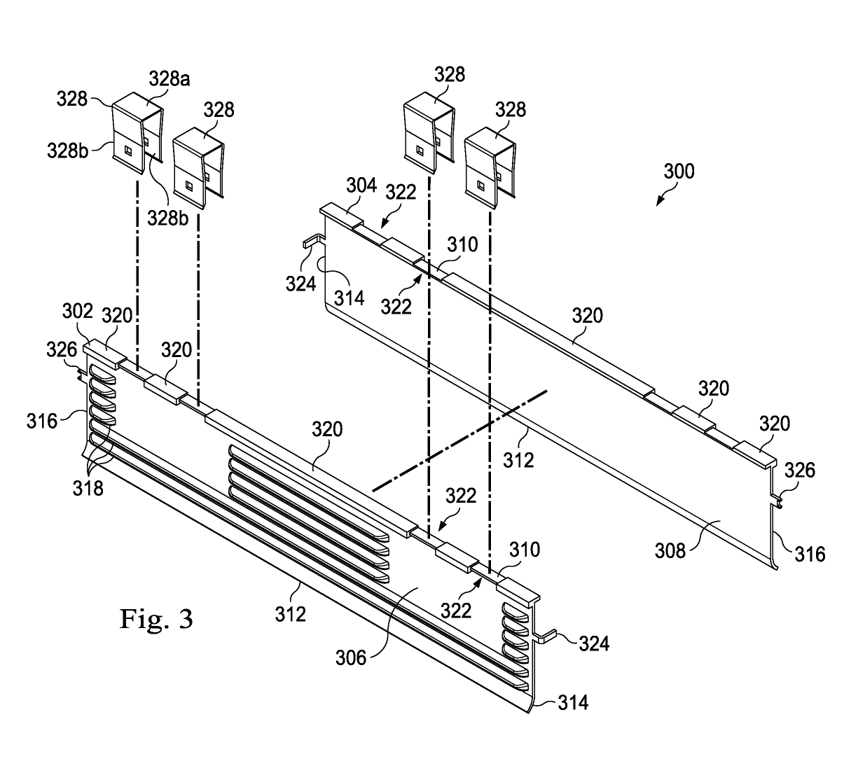

Referring now to FIG. 3, a memory heat sink system 300 is illustrated. The memory heat sink system 300 includes a first base portion 302 and a second base portion 304. In the illustrated embodiment, the first base member 302 and the second base member 304 are substantially identical in structure and operation. Each of the first base portion 302 and the second base portion 304 includes a front side 306 (illustrated on the first base portion 302), a rear side 308 (illustrated on the second base portion 304) located opposite the front side 306, a top side 310 extending between the front side 306 and the rear side 308, a bottom side 312 located opposite the top side 310 and extending between the front side 206 and the rear side 308, and a pair of opposing end sides 314 and 316 extending between the front side 306, the rear side 308, the top side 310, and the bottom side 312. In an embodiment, the front side 306 of each of the first base portion 302 and the second base portion 304 is oriented substantially perpendicularly to the respective top side 310 on each of the first base portion 302 and the second base portion 304. A plurality of convective heat transfer members 318 (illustrated on the first base portion 302) extend from the front side 306 of each of the first base potion 302 and the second base portion 304. In the illustrated embodiment, the plurality of convective heat transfer members 318 include a plurality of fins that extend from the front side 306 of each of the first base portion 302 and the second base portion 304. However, the plurality of convective heat transfer members 318 may include different convective heat transfer structures known in the art without departing from the scope of the present disclosure. In the illustrated embodiment, the plurality of fins are located in a substantially parallel orientation to each other and extend along the length of the front surface 306 of the each of the first base portion 302 and the second base portion 304. However, the plurality of convective heat transfer members 318 may include a variety of different orientations known in the art without departing from the scope of the present disclosure. A plurality of conductive liquid cooling coupling surfaces 320 are located on the top side 310 of each of the first base portion 302 and the second base portion 304. In the illustrated embodiment, each of the plurality of conductive liquid cooling coupling surfaces 320 includes a flat, even surface that is oriented substantially perpendicularly to the front side 306. However, the plurality of conductive liquid cooling coupling surfaces 320 may include different orientations without departing from the scope of the present disclosure. In the illustrated embodiment, the plurality of conductive liquid cooling coupling surfaces 320 include flat, even surfaces that are located in a spaced apart orientation from each other on the top side 310 of each of the first base portion 302 and the second base portion 304 such that they define coupling member slots 322 between them, and each of the flat, even surfaces are substantially co-planar. However, in an embodiment, the conductive liquid cooling coupling surfaces 320 may include one flat, even, interrupted surface adjacent the top side 310 of each of the first base portion 302 and the second base portion 304 and oriented substantially perpendicular to the front side 306 of each of the first base portion 302 and the second base portion 304. A base coupling arm 324 extends from the end side 314 of each of the first base portion 302 and the second base portion 304. A base coupling arm receiver 326 extends from the end side 316 of each of the first base portion 302 and the second base portion 304. In an embodiment, the first base portion 302 and the second base portion 304 may have short conduction paths (e.g., from the rear surface 308 to the front surface 306) and may be fabricated from low conductivity plastics or metals to allow for high volume and low cost stamping, injection molding, or die cast manufacturing. In an embodiment, the first base portion 302, the second base portion 304, and the coupling members 328 are sized and/or include features to allow them to be coupled to a JEDEC compliant memory module. The memory heat sink system 300 also includes a plurality of coupling members 328 each including a top wall 328a and a pair of side walls 328b that extend from opposing sides of the top wall 328a. In the illustrated embodiment, the side walls 328b include distal ends that are located opposite the top wall 328a and that are spaced a distance apart that is shorter than the distance between the opposing sides of the top wall 328a to which they are coupled. While an embodiment of the coupling members 328 has been illustrated and described in detail, one of skill in the art will recognize that a variety of coupling members may be used without parting from the scope of the present disclosure.

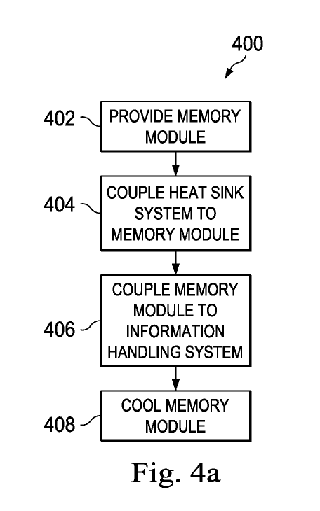

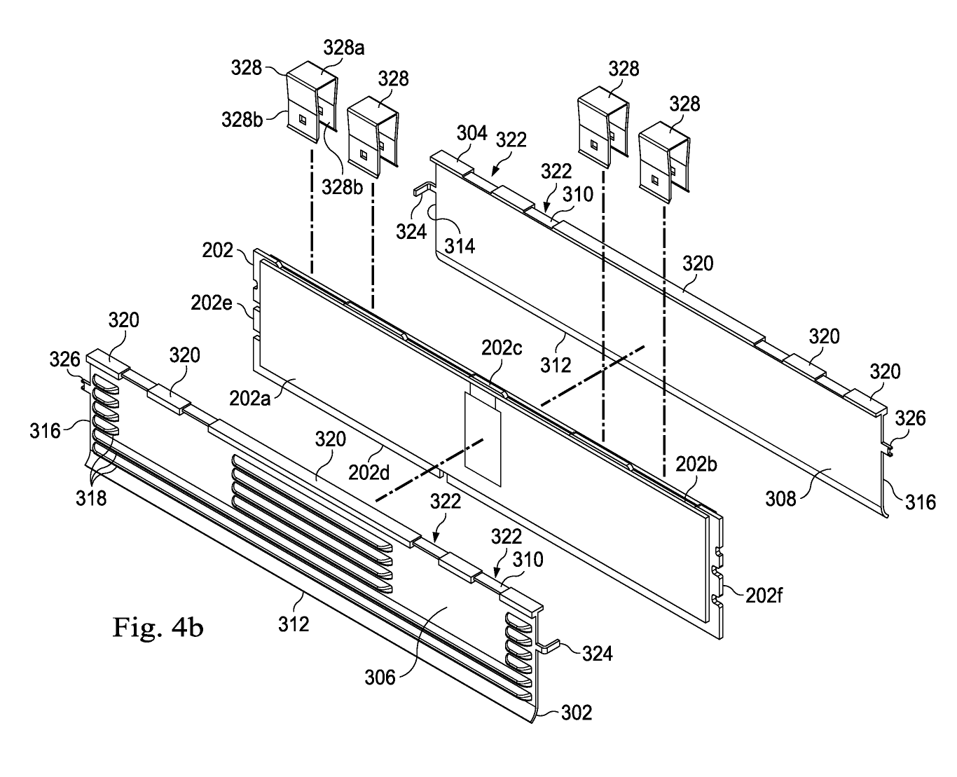

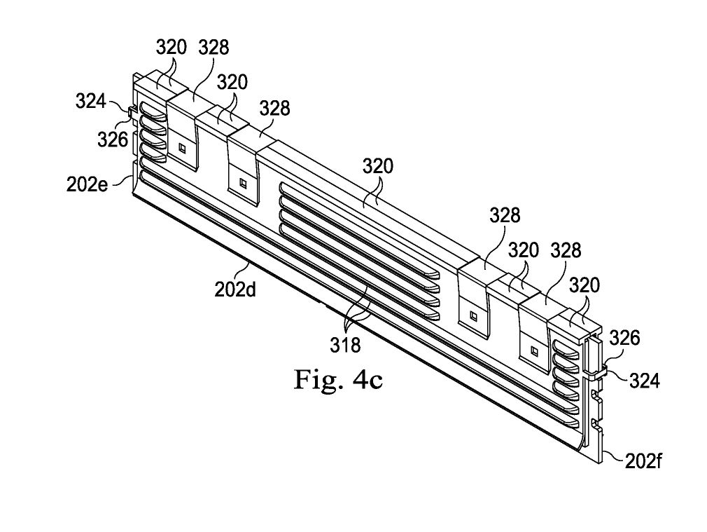

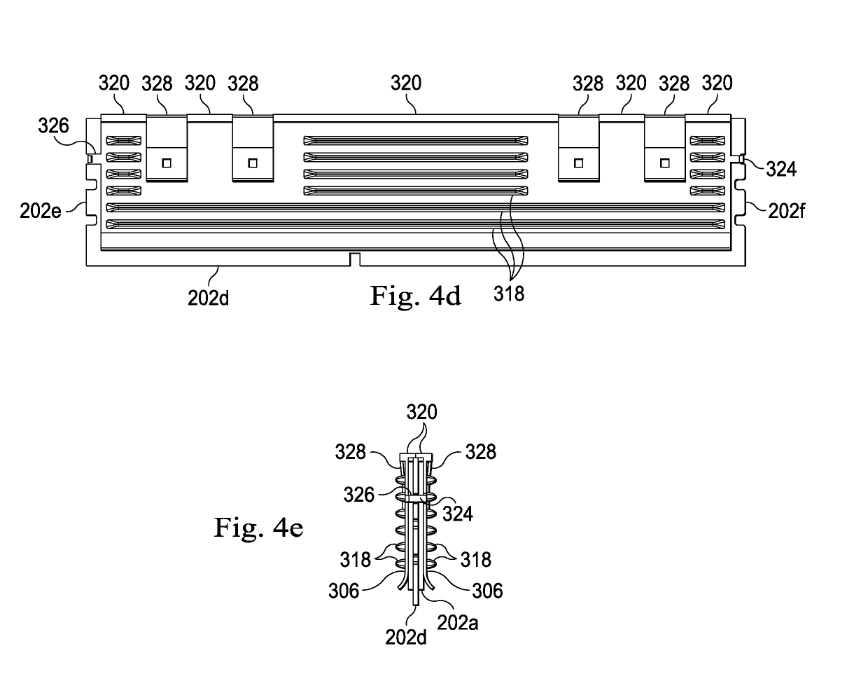

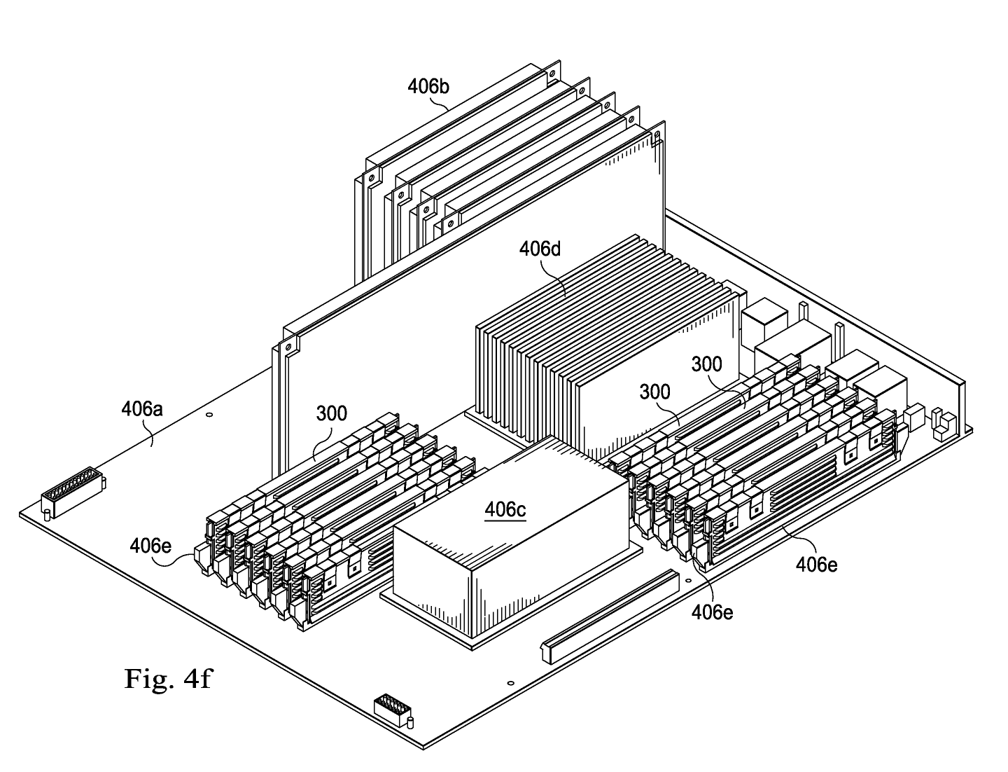

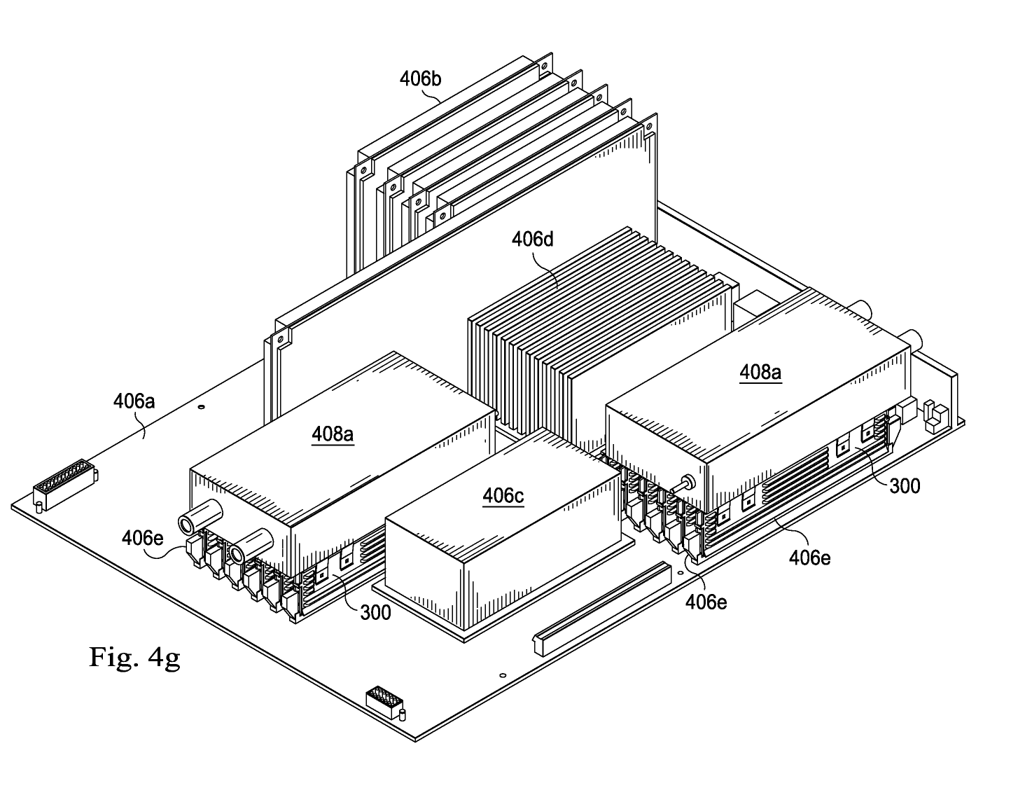

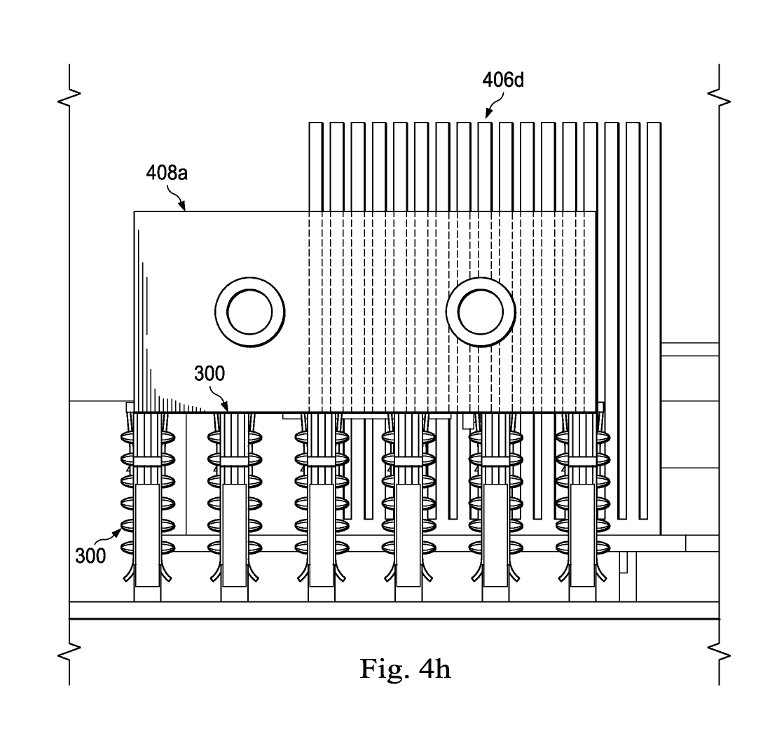

Referring now to FIGS. 4a, 4b, 4c, 4d and 4e, a method 400 for cooling a memory module is illustrated. The method 400 begins at block 402 where a memory module is provided. In an embodiment, the memory module 200, described above with reference to FIG. 2, is provided. The method 400 then proceeds to block 404 where a heat sink system is coupled to the memory module. In the illustrated embodiment, the heat sink system 300 may be coupled to the memory module 200 by positioning the rear side 308 of the first base portion 302 adjacent the front surface 202a of the memory module 200 and the rear side 308 of the second base portion 304 adjacent the rear surface 202b of the memory module 200, as illustrated in FIG. 4b. The rear side 308 of each of the first base portion 302 and the second base portion 304 are then brought into contact with the front side 202a and the rear side 202b of the memory module 200, respectively, and the coupling members 328 are positioned in coupling member slots 322 such that the top wall 328 on each coupling member 328 is located in a respective coupling member slot 322 and the side walls 328b on the coupling member 328 engage one of the first base portion 302 and the second base portion 304, as illustrated in FIGS. 4c, 4d and 4e. As shown in the illustrated embodiments, with the first base portion 302 and the second base portion 304 coupled to the memory module 200 with the coupling members 328, the conductive liquid cooling coupling surfaces 320 are oriented to form a plurality of flat, even surfaces that are located in a spaced apart orientation from each other and that are substantially co-planer with each other.

Referring now to FIGS. 4a, 4c and 4f, the method 400 then proceeds to block 406 where the memory module is coupled to an IHS. In an embodiment, an IHS such as, for example, the IHS 100, described above with reference to FIG. 1, is provided that includes a board 406a with a plurality of IHS components 406b, 406c, and 406d and a plurality of memory module couplers 406e. A plurality of memory modules 200, each including the heat sink system 300 may be coupled to the IHS by positioning the bottom edge 202d of the memory module 200 in a respective memory module coupler 206e, as illustrated in FIG. 4f. The method 400 may then proceed to block 408, where the memory module is cooled. In the embodiment illustrated in FIG. 4f, the memory modules 200 may be cooled using the convective heat transfer members 318 on the heat transfer systems 300. For example, a fan may be used to force a fluid adjacent the convective heat transfer members 318 to transfer heat from the memory module 200, through the memory heat sink system 300, and to the fluid. In an embodiment, the fluid may be air. However, situations may arise where the use of a fan and the convective heat transfer members 318 does not provide enough cooling for the memory modules 200. In that situation, the memory module 200 may be cooled at block 408 using the conductive liquid cooling coupling surfaces 320 on the heat transfer systems 300, as illustrated in FIGS. 4g and 4h. For example, a liquid cooling device 408a maybe coupled to a plurality of heat sink systems 300 (located on the memory modules 200 that were coupled to the memory module couplers 406e on the IHS in block 406 of the method 400) by placing the liquid cooling device 408a adjacent the conductive liquid cooling coupling surfaces 320 on the heat sink systems 300. In an embodiment, the conductive liquid cooling coupling surfaces 320 on each of the heat sink systems 300 to which the liquid cooling device 408a is to be coupled are all substantially co-planar when the memory modules 200 are coupled to the memory module couplers 406e on the IHS, and the liquid cooling device 408a is engaged with all of the heat sink systems 300 by moving the liquid cooling device 408a towards the heat sink systems 300 until the liquid cooling device 408a engages each of the heat sink systems 300 (through the conductive liquid cooling coupling surfaces 320), as illustrated in FIG. 4h. However, one of skill in the art will recognize that they liquid cooling device 408a may include a variety of shapes and orientations that allow the liquid cooling device 408a to engage each of the heat sink systems 300 on the memory modules 200. Heat may then be transferred from the memory module 200, through the memory heat sink system 300, and to a fluid that flows through the liquid cooling device 408a.

In an experimental embodiment, a computational fluid dynamics (CFD) analysis was conducted to understand the memory cooling improvements with a finned memory heat sink with and without a cold plate. A CFD model of the double-data-rate three synchronous dynamic random access memory (DDRIII) was used. FIG. 5 shows a cut plane through the memory for the baseline module with a plastic heat sink with a conductivity of 35 W/m/k with forced convection cooling with approach velocity of 150 fm and approach temperature of 35 C. From this figure it can be seen that there is moderate temperature rise through the memory module. Another model was constructed with a constant temperature (40 C) coldplate in contact with the top surface of the memory plastic heat sink. The results of this analysis are shown in FIG. 6. From this analysis, it can be seen that the coldplate drastically reduces memory module temperatures.

Thus, a heat sink system is provided for a memory module that includes convective heat transfer members and a conductive liquid cooling coupling surface in order to allow the heat sink system to be used either using convective heat transfer or conductive liquid cooling. In situations where only convective heat transfer is needed, a fan may be used to force air past the convective heat transfer members in order to cool the memory module. In situations where more cooling is needed, the liquid cooling device may be coupled to the conductive liquid cooling coupling surface on the heat transfer member in order to cool the memory module. Such a heat transfer system allows the choice of convective cooling or conductive liquid cooling to be made or changed without the need to remove the memory modules from the IHS in order to provide the appropriate heat sink to facilitate the desired cooling method.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A memory heat sink system, comprising:
a base comprising a first side and a second side, wherein the first side is oriented substantially perpendicularly to the second side;
a plurality of convective heat transfer members extending from the first side; and
at least one conductive liquid cooling coupling surface located on the second side.

2. The system of claim 1, wherein the base comprises a first base portion and a second base portion, and wherein the first base portion and the second base portion are operable to couple to opposite sides of a memory module.

3. The system of claim 2, further comprising:
a coupling member that is operable to engage the first base portion and the second base portion in order to couple the first base portion and the second base portion to the memory module.

4. The system of claim 1, wherein the plurality of convective heat transfer members comprise a plurality of fins that extend from the first side of the base.

5. The system of claim 4, wherein the plurality of fins are located in a substantially parallel orientation to each other and extend along the length of the first side.

6. The system of claim 1, wherein the at least one conductive liquid cooling coupling surface comprises a flat, even surface that is oriented substantially perpendicularly to the first side.

7. The system of claim 1, wherein the at least one conductive liquid cooling coupling surface comprises a plurality of flat, even surfaces that are located in a spaced apart orientation from each other and that are substantially co-planer with each other.

8. An information handling system, comprising:
a board;
a processor coupled to the board;
a memory module coupled to the board and the processor; and
a memory heat sink system coupled to the memory module, wherein the memory heat sink system comprises:
a base comprising a plurality of first sides and a second side, wherein the plurality of first sides are oriented substantially perpendicularly to the second side, and wherein the base is coupled to the memory module;
a plurality of convective heat transfer members extending from each of the plurality of first sides; and
at least one conductive liquid cooling coupling surface located on the second side.

9. The system of claim 8, wherein the base comprises a first base portion and a second base portion, and wherein the first base portion and the second base portion are operable to couple to opposite sides of the memory module.

10. The system of claim 9, further comprising:
a coupling member that is operable to engage the first base portion and the second base portion in order to couple the first base portion and the second base portion to the memory module.

11. The system of claim 8, wherein the plurality of convective heat transfer members comprise a plurality of fins that extend from each of the plurality of first sides of the base.

12. The system of claim 11, wherein the plurality of fins are located in a substantially parallel orientation to each other and extend along the length of each of the plurality of first sides.

13. The system of claim 8, wherein the at least one conductive liquid cooling coupling surface comprises a flat, even surface that is oriented substantially perpendicularly to each of the plurality of first sides.

14. The system of claim 8, wherein the at least one conductive liquid cooling coupling surface comprises a plurality of flat, even surfaces that are located in a spaced apart orientation from each other and that are substantially co-planer with each other.

15. The system of claim 8, further comprising:
a liquid cooling device engaging the at least one conductive liquid cooling coupling surface.

16. The system of claim 8, further comprising:
a plurality of memory modules coupled to the board and the processor;
a memory heat sink system coupled to each of the plurality of memory modules, each memory heat sink system comprising:
a base comprising a plurality of first sides and a second side, wherein the plurality of first sides are oriented substantially perpendicularly to the second side, and wherein the base is coupled to the memory module;
a plurality of convective heat transfer members extending from each of the plurality of first sides; and
at least one conductive liquid cooling coupling surface located on the second side; and
a single liquid cooling device engaging each of the at least one conductive liquid cooling coupling surfaces on each of the memory heat sink systems.

17. A method for cooling a memory module, comprising:
providing a memory module;
coupling a memory heat sink system to the memory module, wherein the memory heat sink system comprises a base including a first side having a convective heat transfer member and a second side having a least one conductive liquid cooling coupling surface, wherein the first side is oriented substantially perpendicularly to the second side;
coupling the memory module to an information handling system; and
cooling the memory module using one of either the convective heat transfer member and the conductive liquid cooling coupling surface.

18. The method of claim 17, wherein the cooling the memory module using the convective heat transfer member comprises forcing a fluid adjacent the convective heat transfer member to transfer heat from the memory module, through the memory heat sink system, and to the fluid.

19. The method of claim 17, wherein the cooling the memory module using the conductive liquid cooling surface comprises coupling a liquid cooling device to the conductive liquid cooling coupling surface to transfer heat from the memory module, through the memory heat sink system, and to a fluid that flows through the liquid cooling device.

20. The method of claim 17, wherein the coupling the memory heat sink system to the memory module further comprises:
positioning a first base portion of the base immediately adjacent a first memory module side of the memory module;
positioning a second base portion of the base immediately adjacent a second memory module side of the memory module, wherein the second memory module side is opposite the first memory module side on the memory module; and
engaging the first base portion and the second base portion with a coupling member to couple the first base portion and the second base portion to the memory module.
